(19) United States
(12) Patent Application Publication
(10) Pub. No.: US 2010/0032181 A1
(43) Pub. Date: Feb. 11, 2010

(54) Installation construction for electrical box

(75) Inventors: Zhijun Zhang, Beijing (CN); Haiqing Li, Beijing (CN)

Correspondence Address: YH CHAN, 42 PIN OAKS DRIVE, PHOENIXVILLE, PA, 19460, US

(73) Assignee: BEIJING HAILIN AUTO CONTROL EQUIPMENT CO., LTD., Beijing (CN)

(21) Appl. No.: 12/275,187

(22) Filed: Nov. 20, 2008

(30) Foreign Application Priority Data
Aug. 5, 2008 (CN) 200810117751.6

(51) Int. Cl. H02B 1/30

(52) U.S. Cl. 174/61

(57) ABSTRACT

The present invention discloses an installation construction for an electrical box which comprises a mounting fastener and a mounting aperture on an electrical box; the mounting fastener is of a thin fastener shape with a defined thickness, and is disposed with a construction for securing onto a wall face; the mounting aperture is located on a bottom face of the electrical box, and has a depth dimension which corresponds with the thickness of the mounting fastener, and a transverse cross-sectional shape and dimension which correspond with a transverse cross section of the mounting fastener; an interlocking construction is disposed between the mounting fastener and the mounting aperture, the electrical box can be secured in place by directly inserting the mounting aperture to the mounting fastener. In comparison with the prior arts, the present invention provides an installation construction for an electrical box which requires simply securing a mounting fastener with an area far smaller than that of a mounting bottom plate in the prior art onto a wall face. Conveniently, by means of inserting the electrical box onto the mounting fastener, the electrical box could be secured in place. As the mounting fastener and the electrical box can be directly and accordingly engaged with each other, when the electrical box has to be dismounted, a disengaging action is not first required, thereby simplifying a mounting and dismounting action.

### BACKGROUND OF THE INVENTION

The present invention relates to an installation construction and more particularly pertains to an installation construction for an electrical box.

An electrical box refers to a box-shaped device in which the interior part is used for placing electronic and electrical parts. Electrical circuits therein are generally used to perform certain control and detection functions. An outer part of the box mainly prevents exposures of electronic and electrical parts, provides an insulation protection therefor, and can further provide a mounting face for electronic and electrical parts. A multiple gearing control box of a ceiling fan often used in daily living is a typical example of an electrical box.

Many electrical boxes have to be mounted on a wall face or other surfaces when in use. The prior arts have already provided several methods for mounting electrical boxes on wall faces or other surfaces.

As referred to in FIGS. 1 to 3, the drawings show a method commonly used for mounting electrical boxes on wall surfaces.

FIG. 1 shows an outer appearance of an electrical box. The electrical box 1 comprises an upper casing 101 and a bottom plate 102. The upper casing 101 is a box with an opening on one side. The bottom plate 102 is a plate-shaped part corresponding with the opening of the upper casing 101. The two are interlocked on the opening face of the upper casing 101 by means of a specifically disposed connection construction. The connection construction is a removable construction, so as to enable the upper casing 101 and the bottom casing to be interconnected as an integral body, and to be separated from each other. A view angle in FIG. 1 shows an interconnecting connection construction between the upper casing 101 and the bottom plate 102 on the bottom part of the electrical box 1. The drawing shows that the connection construction can be removed by means of a screwdriver.

FIG. 2 shows the upper casing 101 after being separated from the bottom plate 101. The upper casing 101 cannot be mounted directly on a wall.

FIG. 3 shows the bottom plate 102, both the left and the right sides of the bottom plate 102 have symmetrically disposed apertures. The bottom plate 102 can be secured on a wall face by screws via the apertures.

To secure the electrical box 1 on a wall face, the upper casing 101 and the bottom plate 102 of the electrical box 1 are first separated. Then, the bottom plate 102 is secured on the wall face by means of screws and so on. Lastly, the upper casing 101 and the bottom plate 102 are connected as an integral body via the connection construction thereof, thereby securing the entire electrical box 1 in place.

The abovementioned installation means has many problems. Firstly, the electrical box 1 itself is sold as an integral unit and exists as an integral unit when being in use. However, in an installation process, the upper casing 101 and the bottom plate 102 have to be separated, thereby resulting in an unnecessary waste of time. Secondly, after the bottom plate 102 is secured, and when the upper casing 101 and the bottom plate 102 are connected, as the position of the bottom plate 102 has already been fixed, the operation to secure the upper casing 101 and the bottom plate 102 is relatively difficult. Particularly, under the situation that the upper casing 101 is also disposed with many electrical parts therein, the operation is even more difficult. Lastly, the operation for dismounting the electrical box 1 similarly requires separating the upper casing 101 and the bottom plate 102 by a disassembling tool first, and then removing the bottom plate 102 from the secured position of the wall face, thereby causing difficulty in dismantling and also requiring the use of tools.

To solve the abovementioned problems, the prior art further provides a securing means for an electrical box by adopting a stand-alone mounting bottom plate. The electrical box is equipped with a stand-alone mounting bottom plate. The mounting bottom plate can be mounted on a wall face, and the upper surface thereof and the back face of the electrical box are respectively disposed with a construction which enables the two to be interconnected. As a result, the electrical box could be inserted directly onto the mounting bottom plate and get secured.

FIGS. 4 and 5 show an example of the electrical box mounting method.

As illustrated in FIG. 4, the drawing shows a specific mounting bottom plate 103. The mounting bottom plate 103 has screw threaded holes 103-1 thereon for securing it onto a wall face, and further has three hooks 103-2 for insertions of mounting grooves of an electrical box 1. The mounting bottom plate 103 can be secured onto a wall face by means of screws which pass through the screw threaded holes 103-1.

As illustrated in FIG. 5, the drawing shows the interconnecting method of the electrical box 1 and the mounting bottom plate 103. It can be seen that after the mounting bottom plate 103 is secured onto a wall face, the electrical box 1 can be directly hanged on the hooks 103-2 on the mounting bottom plate 103 via mounting slots 102-1 thereon, so that the electrical box gets secured. The detailed method isas follows: insert the mounting slots 102-1 of the electrical box 1 in the hooks 103-2 of the mounting bottom plate 103 respectively, then apply a force downwardly so that the hooks 103-2 of the electrical box 1 are interlocked with the mounting slots, thereby securing the electrical box in place. When dismounting is required, simply move the electrical box 1 upward so that the connection between the mounting slots 102-1 and the hooks 103-2 are disabled, and then remove the electrical box 1.

The positions of the hooks and the mounting slots in the abovementioned example is interchangeable, that is, the mounting bottom plate 103 is disposed with mounting slots thereon, and the back face of the electrical box 1 is disposed with hooks.

In the abovementioned installation means, the electrical box 1 is not required to be disassembled and reassembled. It is only required to engage the electrical box 1 to the mounting bottom plate 103 which has already been secured on a wall face, thereby saving time. Further, after the mounting bottom plate 103 is secured, the mounting and dismounting of the electrical box 1 are attained without any tool aid. Apparently, the securing means has a significant improvement vis-à-vis the first type of installation means of an electrical box.

However, this securing means of the electrical box similarly has significant shortcomings. Firstly, when the electrical box secured by the securing means has to be dismounted, as the securing means cannot be observed, a worker does not know how to dismount the electrical box and therefore damages of the electrical box are often caused by inappropriate pulling and dragging. Besides, after the electrical box is dismounted from the wall face, the mounting bottom plate 103 is still secured on the wall face. As it occupies a very large area, it looks bad if it is not dismounted, whereas dismounting requires use of a tool. Lastly, the use of this securing means has a strict requirement with respect to the distances between the hooks 103-2 of the mounting bottom plate 103. When it is necessary to replace an electrical box with another model on a same place, the mounting bottom plate 103 usually has to be replaced as well, thereby lengthening the installation time and causing a waste of materials.

### BRIEF SUMMARY OF THE INVENTION

In view of the abovementioned shortcomings, the technical problems solved by the present invention is as follows: provide an installation construction for an electrical box. The installation construction for an electrical box enables the electrical box to be mounted on a wall face or other surfaces more conveniently and dismounted easily.

The present invention provides an installation construction for an electrical box which comprises a mounting fastener and a mounting aperture on the electrical box. The mounting fastener is of a thin fastener shape with a defined thickness, and is disposed with a construction for securing onto a wall face. The mounting aperture is located on a bottom face of the electrical box, and has a depth dimension which corresponds with the thickness of the mounting fastener, and a transverse cross-sectional shape and dimension which correspond with a transverse cross section of the mounting fastener. An interlocking construction is disposed between the mounting fastener and the mounting aperture. The electrical box can be secured in place by directly inserting the mounting aperture to the mounting fastener.

Preferably, an interior portion of the mounting aperture is lined with a basin-shaped female fastener which at least partially engages with a bottom edge and a periphery thereof. The female fastener has an outward extending elasticity, so as to be capable of tightly engaging with a surface of the interior portion of the mounting aperture of the electrical box by an elastic force. The female fastener is disposed with a female fastener ring groove which surrounds its inner periphery at a position in proximity to an opening of the female fastener. The female fastener ring groove is disposed with a female fastener ring of a looped strip shape therein. An outer periphery of the mounting fastener has an outward elasticity, and a mounting fastener groove which surrounds the outer periphery is disposed at a position corresponding to the female fastener ring. The electrical box can be secured in place by directly inserting the mounting aperture to the mounting fastener. Specifically, when the electrical box is inserted onto the mounting fastener, the female fastener ring which is disposed in the female fastener ring groove enters into the mounting fastener groove, so as to secure the electrical box on the mounting fastener.

Preferably, a symmetrical central position of the mounting fastener has a central aperture. The mounting aperture of the electrical box has a central post with its shape and dimension corresponding to the central aperture. The central post extends through the female fastener. When the electrical box is inserted onto the mounting fastener, the central post is inserted into the central aperture of the mounting fastener.

Preferably, the mounting fastener has at least one positioning aperture thereon. The positioning apertures are respectively located at unsymmetrical central position on an upper surface of the mounting fastener. The mounting aperture of the electrical box has respective positioning posts therein which correspond to the positioning apertures. The positioning posts extend through the female fastener. When the electrical box is inserted onto the mounting fastener, the positioning posts are inserted into the corresponding positioning apertures on the mounting fastener respectively.

Preferably, root parts of the central post and/or the positioning posts have elevations oriented towards a bottom part of the mounting aperture. After the female fastener is installed in the mounting aperture, the elevation faces hold the female fastener precisely.

Preferably, the central post and/or the positioning posts have inverted elastic spikes opened towards the bottom part of the mounting aperture. In an operating state, the inverted elastic spikes are hedged in the central aperture and/or the positioning apertures of the mounting fastener, the outward elastic tension force of the inverted elastic spikes is imposed on the electrical box via the central aperture and/or the positioning apertures.

Preferably, the periphery of the top face of the mounting fastener has an upward elastic protrusion. When the electrical box is inserted onto the mounting fastener, the elastic protrusion presses on the inner bottom face of the female fastener, the elastic force of the elastic protrusion thereby generates a tension force between the mounting fastener and the electrical box in perpendicular to the direction of a wall face.

Preferably, the rim of the mounting aperture has an inwardly detent beveled positioning face. The beveled positioning face can hold the female fastener.

Preferably, the installation mechanisms of the mounting fastener and a wall face comprise any of the following means:
Apertures are disposed on the mounting fastener, the mounting fastener is mounted on a wall face by means of screws;
Glue is disposed on a back face of the mounting fastener, the mounting fastener is stuck on a wall face by means of an adhesive means;
A suction chassis is disposed on the back face of the mounting fastener, the mounting fastener is sucked on a wall face by means of a vacuum suction.

In comparison with the prior arts, the present invention provides an installation construction for an electrical box which requires simply securing a mounting fastener with an area far smaller than that of a mounting bottom plate in the prior art onto a wall face. Conveniently, by means of inserting the electrical box onto the mounting fastener, the electrical box could be secured in place. As the mounting fastener and the electrical box can be directly and accordingly engaged with each other, when the electrical box has to be dismounted, a disengaging action is not first required, thereby simplifying mounting and dismounting action.

After adopting the installation construction provided by the present invention, the mounting fastener occupies a very small area on a wall face, and does not have a significant impact on a wall face. Under most situations, the tedious dismounting process which requires a tool aid can be avoided.

As for the construction of the mounting bottom plate adopted in the prior art, the discrepancies of the distances between the plurality of mounting slots or hooks have to be under strict control, and the requirement on the correspondence thereof with the electrical box is relatively high. Another electrical box, most possibly, cannot be used with the previous mounting bottom plate. The present invention provides a corresponding construction between the mounting fastener and the electrical box which attains an engagement by means of elastic raw parts and thereby allowing wider tolerance and basically avoiding the occurrence of a situation which has to change a mounting fastener at the same time while an electrical box is being replaced, thus saving cost and time.

### BRIEF DESCRIPTION OF THE DRAWINGS

FIG. 1 is a view of an external appearance of a commonly used electrical box in the prior art.

FIG. 2 is the top casing of the abovementioned electrical box.

FIG. 3 is the bottom plate of the abovementioned electrical box.

FIG. 4 is the mounting bottom plate employed by another electrical box securing construction in the prior art.

FIG. 5 is a view showing the engagement of the electrical box body which has an electrical box and the mounting bottom plate.

FIG. 6 is a cross-sectional view of the installation construction of the embodiment of the present invention.

FIG. 7 is a perspective view of the mounting fastener of the embodiment of the present invention.

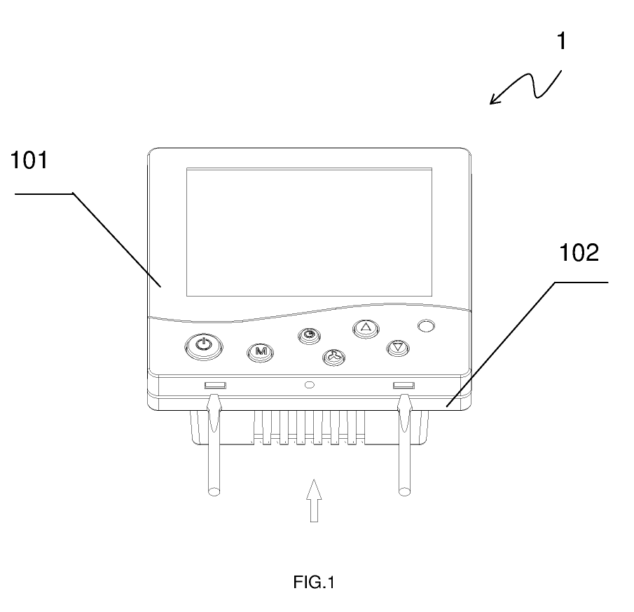

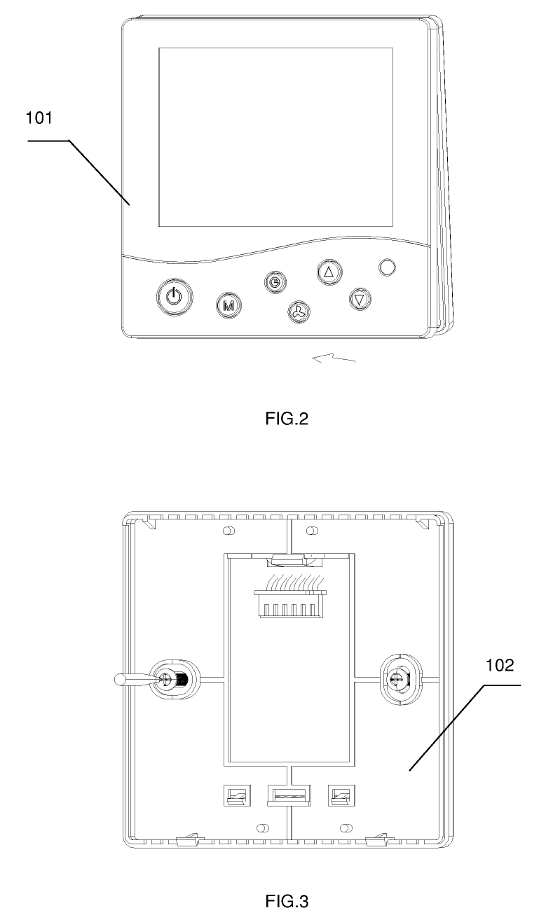

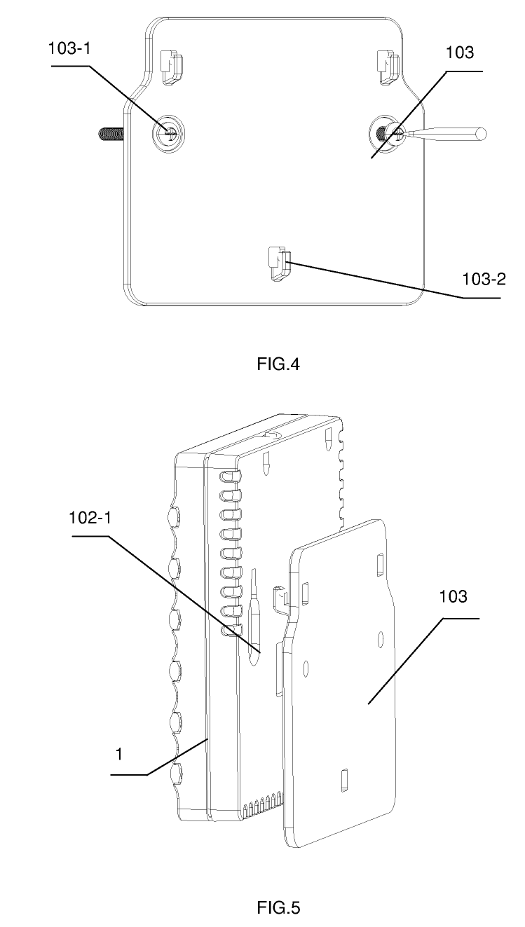

### DETAILED DESCRIPTION OF THE INVENTION

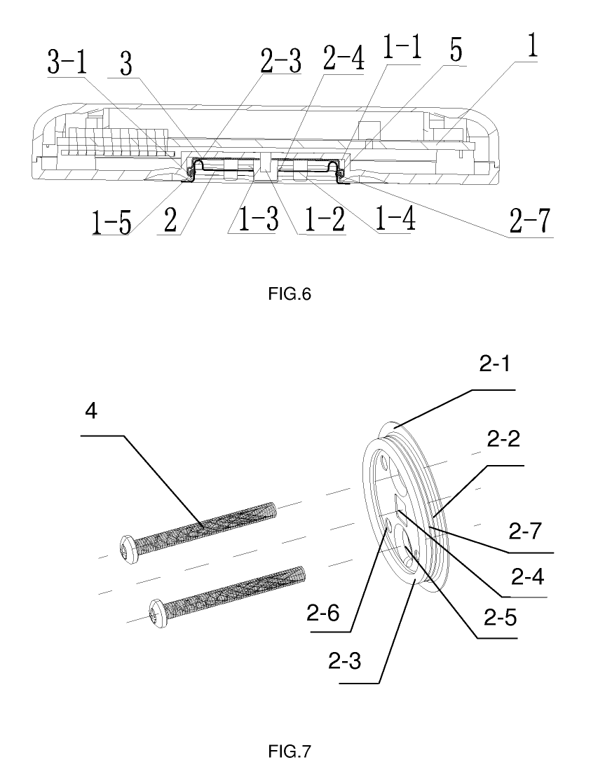

As referred to FIG. 6, the drawing shows the first embodiment of the present invention which provides an installation construction for an electrical box, wherein the bold black line represents the interconnecting area in between the installation construction.

The construction comprises a mounting fastener 2 and a mounting aperture 1-1 on an electrical box 1, and a female fastener 3 lining within the mounting aperture 1-1.

As simultaneously referred to FIG. 7, the drawing shows a perspective view of the mounting fastener 2.

The mounting fastener 2 is of a thin fastener shape with a certain thickness. Its transverse cross section can be of a rectangular shape, a circular shape, and so on. A circular shape is generally adopted as shown in the drawing. When the mounting fastener 2 is in use, the part in proximity to a wall face is a mounting fastener bottom plate 2-1. The mounting fastener bottom plate 2-1, located on the bottom part of the mounting fastener 2, is a thin layer with a transverse cross-sectional diameter slightly greater than that of a main body 2-2. In use, the bottom face of the mounting fastener bottom plate 2-1 is employed to engage tightly with a wall face. The mounting fastener bottom plate 2-1 can increase the engaging area between the mounting fastener 2 and the wall face. The main body 2-2 of the mounting fastener 2 takes up a great portion of the thickness of the mounting fastener 2; its interior is hollow, and its outer diameter is disposed with a groove thereon which is described as a mounting fastener groove 2-7. Its function will be described hereinafter with respect to the operating principles of the installation construction. The top face of the mounting fastener 2, that is, the distal side to the wall face when in use, has a circular upward elastic protrusion 2-3 on its periphery. The symmetrical central position of the top face of the mounting fastener 2 has a central aperture 2-4. The transverse cross sectional shape of the central aperture 2-4 can be of a circular shape, or of a rectangular shape, or of other various shapes. The top face of the mounting fastener 2 is further disposed with screw apertures 2-5, each with an elevation. Each elevation face of the elevations is orientated towards the top face. The number of the screw apertures 2-5 can be determined according to the requirement. In the present embodiment, there are two screw apertures 2-5 in total. As illustrated in FIG. 7, a securing screw 4 passes through each of the screw apertures 2-5 so as to firmly mount the mounting fastener 2 onto the wall face by means of screw thread connection. The top face of the mounting fastener 2 further has positioning apertures 2-6 disposed on the unsymmetrical central positions respectively, the number of which can be one or more. FIG. 7 shows three positioning apertures 2-6. The mounting fastener 2 is manufactured with a material having a certain elasticity, so as to achieve the engagement with the electrical box 1.

The mounting fastener 2 has to be used with the mounting aperture 1-1 on the electrical box 1, so as to position the electrical box 1. The engagement between the mounting fastener 2 and the mounting aperture 1-1 of the electrical box 1 has to rely on the elastic force therebetween, but the elasticity of the material of the electrical box 1 itself is limited. Therefore, in the present embodiment, the mounting aperture 1-1 is disposed with a female fastener 3, lining therein. Actually, the mounting aperture 1-1 of the electrical box 1 may be directly disposed with the connection construction be associated with the mounting fastener 2, and in practice it is possible not to employ the female fastener 3. Therefore, the female fastener 3 can be deemed as an integral part of the mounting aperture 1-1.

The mounting aperture 1-1 and the female fastener 3 of the present embodiment are described respectively as follows:

The mounting aperture 1-1 is disposed on the bottom part of the electrical box 1. In the present embodiment, the mounting aperture 1-1 is a circular aperture. The diameter of the circular aperture corresponds with the diameter of the main body of the mounting fastener 2, the engagement between the two could be in the form of interference fit, transition fit, clearance fit and so forth. The firm engagement between the two depends on an installation locking construction and elastic force between the two as described hereinafter. The center of the mounting aperture 1-1 has a central post 1-2 with its shape and dimension fit in with the central aperture 2-4. The central post 1-2 has inverted elastic spikes 1-3for increasing the interactive force between the electrical box 1 and the mounting fastener 2 after it is inserted into the central aperture 2-4. The mounting aperture 1-1 has positioning posts 1-4 corresponding to the positioning apertures 2-6. The positioning posts 1-4 correspond to the positions and dimensions of the positioning apertures 2-6 respectively and penetrate into the positioning apertures 2-6 of the mounting fastener 2 when in use. The periphery of the opening of the mounting aperture 1-1 has an inwardly detent beveled positioning face 1-5. The beveled positioning face 1-5 can hold the female fastener 3.

The female fastener 3 is a basin-shaped part, lining the interior of the mounting aperture 1-1. The female fastener 3 at least partially engages with the bottom and the periphery of the mounting aperture 1-1. The female fastener 3 has an outwardly extending elasticity, so as to be able to tightly engage with the interior surface of the mounting aperture 1-1 of the electrical box 1 by elastic force. The position in proximity to the opening of the female fastener 3 has a female fastener ring groove 3-1 surrounding its inner periphery. The female fastener ring groove 3-1 is disposed with a female fastener ring 5 of a looped strip shape therein. The female fastener 3 is disposed with corresponding apertures thereon for the central post 1-2 and the positioning posts 1-4 of the mounting aperture 1-1, so as to enable the female fastener 3 to engage the central post 1-2 and the positioning posts 1-4 and be pressed into the mounting aperture 1-1. The root parts of the central post 1-2 and the positioning posts are each disposed with an elevation oriented towards the bottom part of the mounting aperture 1-1, and the elevation faces of the elevations are very small. The female fastener 3 is manufactured with an elastic material, so that the diameters of the apertures disposed thereon have a certain flexibility. In the process of pressing the female fastener 3 into the mounting aperture 1-1, the apertures are plied open respectively by the central post 1-2 or the positioning posts 1-4. When the installation is completed, the diameters of the apertures contract and are held by the elevations, respectively, so that the female fastener 3 does not come off.

The operating principles of the installation construction are as follows:

Firstly, the mounting fastener 2 is mounted onto a wall face where the electrical box 1 is intended to be secured. In the present embodiment, pass the two securing screws 4 through the screw apertures 2-5 respectively so as to fix the mounting fastener 2 onto a wall face.

The female fastener 3 has to be pressed into the mounting aperture 1-1 on one side of the electrical box 1. When being pressed in, as the respective apertures of the female fastener 3 have to correspond with the central post 1-2 and the positioning posts 1-4 in the mounting aperture 1-1, the female fastener 3 can be pressed into the mounting aperture 1-1 at a specific angle. After being pressed in, as the elevations of the root parts of the central post 1-2 and the positioning posts 1-4 can hold the female fastener 3, and the beveled positioning face 1-5 on the periphery of the mounting aperture 1-1 limits the outer rim of the female fastener 3, and in addition, the outer periphery of the female fastener 3 has an outward tension force when being pressed, the above factors cause the female fastener 3 to be held tightly in the mounting aperture 1-1, thereby not getting loosened and making a reliable steadiness for the electrical box 1 possible.

After the above preparatory processes are completed, simply aim and insert the mounting aperture 1-1 of the electrical box 1 to the position where the mounting fastener 2 is located to secure the electrical box 1 onto the wall face. When the electrical box 1 is inserted onto the mounting fastener 2, the female fastener ring 5 presses on the outer periphery face of the mounting fastener 2, so as to cause the mounting fastener 2 to contract inwardly; and after it reaches the bottom, the female fastener ring 5 is lodged into the mounting fastener groove 2-7 of the mounting fastener 2, and the female fastener 3 is thereby held by means of the female fastener ring 5. At this time, the elastic protrusion 2-3 of the periphery of the top face of the mounting fastener 2 presses on the inner bottom face of the female fastener 3, thereby causing a tension force in perpendicular to the wall face to be generated between the mounting fastener 2 and the electrical box 1 due to the elastic force of the elastic protrusion 2-3, and causing the electrical box 1 to have an outwardly butting elastic force in perpendicular to the wall face, so as to make it more steady and not susceptible to sway. The mounting fastener 2 also generates an outwardly extending elastic force due to the reaction force, thereby causing the female fastener ring 5 to hold tighter. As the central post 1-2 and the positioning posts 1-4 also have to extend into the central aperture 2-4 and the positional apertures 2-6 of the mounting fastener 2 respectively, the electrical box 1 has to be inserted into the mounting fastener 2 at a certain installation angle. As such, the installation angle of the electrical box 1 can be defined when the installation of the mounting fastener 2 is completed. The central post 1-2 and the positioning posts 1-4 each has inverted elastic spikes 1-3. The inverted elastic spikes 1-3 are hedged in by the corresponding central aperture 2-4 and the positioning apertures 2-6 respectively. The compressing force between the inverted elastic spikes 1-3 and the apertures renders the electrical box 1 more reliably secured on the mounting fastener 2. When the electrical box 1 has to be taken off, it is attainable by simply applying a force to pull the electrical box 1 outward. As the connection between the electrical box 1 and the mounting fastener 2 is an interconnection entirely relying on the elastic force, thereby by simply applying a certain external force, the elastic force can be overcome so that the electrical box 1 is pulled out. Therefore, the present installation mechanism has a significant advantage of convenience in plugging and pulling out.

The abovementioned embodiment is merely a preferred embodiment of the present invention. Actually, the core of the present invention is to employ a stand-alone mounting fastener 2 and dispose an mounting aperture 1-1 on the back face of the electrical box 1, and achieve the installation of the electrical box 1 by interconnecting the mounting fastener 2 and the mounting aperture 1-1. As to the specific attaining means, various alternative schemes are available. For example, the mounting fastener 2 can adopt various means to connect with the wall face. Besides the means provided in the abovementioned embodiments, the back face of the mounting fastener 2 can also be disposed with glue, the mounting fastener 2 is stuck onto the wall face by means of an adhesive means, and the back face of the mounting fastener 2 can also be disposed with a suction chassis which sucks the mounting fastener 2 onto a wall face by means of a vacuum suction means. The interconnection construction between the mounting fastener 2 and the mounting aperture 1-1 can also adopt various specific means which have already been available in the prior arts. For further elaboration, the female fastener 3 can be an optional part and the corresponding construction thereon can be disposed directly in the mounting aperture 1-1.

The above embodiment is merely a preferred embodiment. It should be specified that persons skilled in the art can further make various improvements and modifications which are not deviated from the principles of the present invention. Those improvements and modifications should also be deemed to fall within the scope of the protection of the present invention.

What is claimed is:

1. An installation construction for an electrical box, wherein it comprises a mounting fastener and a mounting aperture on an electrical box; the mounting fastener is of a thin fastener shape with a defined thickness and is disposed with a construction for securing onto a wall face; the mounting aperture is located on a bottom face of the electrical box, and has a depth dimension which corresponds with the thickness of the mounting fastener, and a transverse cross-sectional shape and dimension which correspond with a transverse cross section of the mounting fastener; an interlocking construction is disposed between the mounting fastener and the mounting aperture, the electrical box can be secured in place by directly inserting the mounting aperture to the mounting fastener.

2. An installation construction for an electrical box as in claim 1, wherein an interior portion of the mounting aperture is lined with a basin-shaped female fastener which at least partially engages with a bottom edge and a periphery thereof, the female fastener has an outward extending elasticity, so as to be capable of tightly engaging with a surface of the interior portion of the mounting aperture of the electrical box by an elastic force; the female fastener is disposed with a female fastener ring groove which surrounds its periphery at a position in proximity to an opening of the female fastener, the female fastener ring groove is disposed with a female fastener ring of a looped strip shape therein; an outer periphery of the mounting fastener has an outward elasticity, and a mounting fastener groove which surrounds the outer periphery is disposed at a position corresponding to the female fastener ring; the electrical box can be secured in place by directly inserting the mounting aperture to the mounting fastener, specifically, when the electrical box is inserted onto the mounting fastener, the female fastener ring which is disposed in the female fastener ring groove enters into the mounting fastener groove, so as to secure the electrical box on the mounting fastener.

3. An installation construction for an electrical box as in claim 2, wherein a symmetrical central position of the mounting fastener has a central aperture, the mounting aperture of the electrical box has a central post with its shape and dimension corresponding to the central aperture, the central post extends through the female fastener; when the electrical box is inserted onto the mounting fastener, the central post is inserted into the central aperture of the mounting fastener.

4. An installation construction for an electrical box as in claim 3, wherein the mounting fastener has at least one positioning aperture thereon, the positioning apertures are respectively located at unsymmetrical central position on an upper surface of the mounting fastener; the mounting aperture of the electrical box has respective positioning posts therein which correspond to the positioning apertures, the positioning posts extend through the female fastener; when the electrical box is inserted onto the mounting fastener, the positioning posts are inserted into the corresponding positioning apertures on the mounting fastener respectively.

5. An installation construction for an electrical box as in claim 4, wherein root parts of the central post and/or the positioning posts have elevations oriented towards a bottom part of the mounting aperture, after the female fastener is installed in the mounting aperture, the elevation faces hold the female fastener precisely.

6. An installation construction for an electrical box as in claim 4, wherein the central post and/or the positioning posts have inverted elastic spikes opened towards the bottom part of the mounting aperture, in an operating state, the inverted elastic spikes are hedged in the central aperture and/or the positioning apertures of the mounting fastener, the outward elastic tension force of the inverted elastic spikes is imposed on the electrical box via the central aperture and/or the positioning apertures.

7. An installation construction for an electrical box as in claim 4, wherein the periphery of the top face of the mounting fastener has an upward elastic protrusion, when the electrical box is inserted onto the mounting fastener, the elastic protrusion presses on the inner bottom face of the female fastener, the elastic force of the elastic protrusion thereby generates a tension force between the mounting fastener and the electrical box in perpendicular to the direction of a wall face.

8. An installation construction for an electrical box as in any one of claims 2 to 7, wherein a rim of the mounting aperture has an inwardly detent beveled positioning face, the beveled positioning face can hold the female fastener.

9. An installation construction for an electrical box as in claim 8, wherein installation mechanisms of the mounting fastener and a wall face comprise any of the following means:
apertures are disposed on the mounting fastener, the mounting fastener is mounted on a wall face by means of screws;
glue is disposed on a back face of the mounting fastener, the mounting fastener is stuck on a wall face by means of an adhesive means;
a suction chassis is disposed on the back face of the mounting fastener, the mounting fastener is sucked on a wall face by means of a vacuum suction.

10. An installation construction for an electrical box as in any one of the claims 1 to 7, wherein installation mechanisms of the mounting fastener and a wall face comprise any of the following means:
apertures are disposed on the mounting fastener, the mounting fastener is mounted on a wall face by means of screws;
glue is disposed on a back face of the mounting fastener, the mounting fastener is stuck on a wall face by means of an adhesive means;
a suction chassis is disposed on the back face of the mounting fastener, the mounting fastener is sucked on a wall face by means of a vacuum suction.
